(19) United States
(12) Patent Application Publication
(10) Pub. No.: US 2012/0101193 A1
(43) Pub. Date: Apr. 26, 2012

(54) UNCURED BUTYL RUBBER COMPOSITION CONTAINING A DISPERSION OF DYE COLORED CORN COB GRANULES AND TIRE HAVING AN INNERLINER LAYER COMPRISED OF SAID BUTYL RUBBER

(76) Inventor: Paul Harry Sandstrom, Cuyahoga Falls, OH (US)

(21) Appl. No.: 12/910,897

(22) Filed: Oct. 25, 2010

(51) Int. Cl. C08L 9/00

(52) U.S. Cl. 524/15

(57) ABSTRACT

Uncured black colored butyl rubber composition is provided which contains a dispersion of distinguishing dye colored corn cob granules and tire having an innerliner comprised of said butyl rubber. A means of segregating and visually maintaining separation of said black colored uncured butyl rubber and a black colored rubber composition containing a conjugated diene based elastomer to the exclusion of said butyl rubber is provided.

### FIELD OF THE INVENTION

Uncured black colored butyl rubber composition is provided which contains a dispersion of distinguishing dye colored corn cob granules and tire having an innerliner comprised of said butyl rubber. A means of segregating and visually maintaining separation of said black colored uncured butyl rubber and a black colored rubber composition containing a conjugated diene based elastomer to the exclusion of said butyl rubber is provided.

### BACKGROUND OF THE INVENTION

Pneumatic rubber tire innerliners are typically comprised of a low unsaturation (low carbon-to-carbon double bond unsaturation) butyl-type rubber composition to resist permeation of air and thereby provide suitable air barrier qualities for the tire. Such butyl-type rubbers for tire innerliner layer rubber compositions may comprise, for example, at least one of butyl rubber and halobutyl rubber such as for example chlorobutyl rubber and bromobutyl rubber.

For convenience, such butyl type rubbers are referred to herein as butyl rubber.

Use of butyl rubber based innerliner layers for pneumatic rubber tires to promote air retention is well known to those having skill in such art.

Such butyl-type rubber compositions are generally not suitable for other tire components such as for example tire treads, sidewalls and carcass elements and it is therefore logically desired to keep uncured butyl-type rubber compositions intended for use for preparation of tire innerliner layers segregated from uncured high unsaturation diene elastomer-based rubber compositions in the workplace.

Other tire components, such as the tire tread, sidewalls and carcass components are typically comprised of rubber compositions composed of relatively high unsaturation (relatively high carbon-to-carbon double bond unsaturation) diene-based elastomers to the exclusion of butyl-type elastomers.

However, primarily because of large differences in rate of cure of butyl rubber as compared to the rate of cure of diene based elastomers, as indicated above, it is normally especially important to keep such rubber compositions separate from each other to prevent their cross-contamination, or co-mingling, in the work place until the respective rubber compositions are intended to be individually built into the uncured tire assembly as is well known to those having skill and experience in such art.

Historically, it has been found that corn cob granules can be used in butyl rubber compositions for tire innerliner layers for which the air permeation resistance of the butyl rubber can be largely retained with a benefit of also obtaining suitable physical properties of the butyl rubber while also reducing a significant cost of butyl rubber based tire innerliners. For example, see U.S. Pat. No. 7,134,468.

For this invention it is desired to evaluate whether such corn cob granules can be further useful in visually identifying and thereby segregating the black colored uncured butyl rubber compositions from black colored uncured diene based elastomer compositions in the work place where both elastomers are present prior to building a tire assembly of components where one of the components is a butyl rubber based tire innerliner layer for a pneumatic tire.

Accordingly, it is an aspect of this invention to make such evaluation.

Such uncured butyl rubber compositions for the purposes of this invention are exclusive of diene-based elastomers, exclusive of a dispersion of cured rubber particles, exclusive of starch composites and exclusive of colored dyes other than said dye colored organic corn cob granules.

The term “corncob granules” is used herein to refer to corncob granules which are obtained from the woody ring surrounding the central core, or pith, of the corncob. The corncob granules are manufactured by drying the woody ring portion, or fraction, of the corncob followed by grinding to produce the granules which are air cleaned and separated into various sizes by mesh screening. Such corncob granules are manufactured by The Andersons, Inc. and sold as Grit-O' Cobs® corncob granules, for example as 60 Grit-O' Cobs®. For further corncob granule discussion, see “Use of Fine-R-Cobs as a Filler For Plastics”, by D. B. Vanderhooven and J. G. Moore, reprinted from the Internal Wire and Cable Symposium 1982.

The term “butyl type rubber” is used herein in a general sense of a rubbery isobutylene/conjugated diene copolymer or halogenated isobutylene/conjugated diene copolymer which is typically comprised of from about 1 to about 5 weight percent units derived from said diene, wherein the diene is typically isoprene and is typically simply referred to herein as a butyl rubber. The halogen of said halogenated butyl rubber is typically bromine or chlorine such as for example, a brominated butyl rubber or chlorinated butyl rubber which, for convenience, may also be referred to as being butyl or butyl-type rubber. Butyl rubber and halogenated butyl rubbers are well known to those having skill in such art.

In the description of this invention, the terms “rubber” and “elastomer”, where used, are used interchangeably unless otherwise indicated. The terms “cure” and “vulcanize”, where used, are used interchangeably unless otherwise indicated. The terms “compound” and “rubber composition”, where used, are used interchangeably unless otherwise indicated.

The term “phr” refers to parts by weight of a particular material per 100 parts by weight rubber.

### DISCLOSURE AND PRACTICE OF INVENTION

In accordance with this invention an uncured black colored butyl rubber based rubber composition is provided containing a dispersion of visually identifiable dye colored corn cob granules comprised of:

(A) an uncured black colored butyl rubber composition containing reinforcing carbon black wherein said butyl rubber is comprised of at least one of butyl rubber and halogenated butyl rubber, wherein said halogenated butyl rubber is selected from chlorobutyl rubber and bromobutyl rubber, and

(B) a dispersion within said black colored butyl rubber composition of dye colored corn cob granules, wherein said corn cob granules are colored with a dye adsorbed onto and imbibed within said corn cob granules which imparts color to said corn cob granules, wherein the dyed color of said colored corn cob granules contrasts with the black color of said black colored butyl rubber composition and are visible on the surface of said black colored butyl rubber composition.

In additional accordance with this invention, a pneumatic rubber tire is provided having a sulfur cured integral innerliner of said butyl rubber composition.

In further accordance with this invention, a method of visually segregating (e.g. visually maintaining separation of) uncured black colored butyl rubber composition from black colored uncured conjugated diene elastomer based rubber composition which comprises providing said butyl rubber composition with a dispersion of dye colored corn cob granules, wherein said corn cob granules are colored with a dye adsorbed onto and imbibed within said corn cob granules which imparts color to said corn cob granules, wherein the dyed color of said colored corn cob granules contrasts with the black color of said black colored butyl rubber composition and are visible on the surface of said black colored butyl rubber composition,

wherein said uncured butyl rubber composition contains rubber reinforcing carbon black and butyl rubber comprised of at least one of butyl rubber and halogenated butyl rubber wherein said halogenated butyl rubber is comprised of at least one of chlorobutyl and bromobutyl rubber, and

wherein said uncured conjugated diene elastomer based rubber composition is exclusive of said butyl rubber.

In additional accordance with this invention, in a combination of rubber compositions comprised individually and separately is provided comprised of:

(A) at least one black colored uncured butyl rubber composition which contains rubber reinforcing carbon black and butyl rubber comprised of at least one of butyl rubber and halogenated butyl rubber, and

(B) at least one black colored uncured conjugated diene-based elastomer containing rubber composition which contains rubber reinforcing carbon black and is exclusive of butyl rubber and halogenated butyl rubber;

an identifying means for said black colored uncured butyl rubber composition is provided which comprises:

providing said black colored uncured butyl rubber composition with a dispersion of dye colored corn cob granules dispersion of dye colored corn cob granules, wherein said corn cob granules are colored with a dye adsorbed onto and imbibed within said corn cob granules which imparts color to said corn cob granules, wherein the dyed color of said colored corn cob granules contrasts with the black color of said black colored butyl rubber composition and are visible on the surface of said black colored butyl rubber composition,

wherein said black colored uncured conjugated diene-based elastomer containing rubber composition is exclusive of said dye colored corn cob granules.

While various colored dyes may be used for the dye colored corn cob granules, desirable dye colors to contrast with the black colored rubber composition are, for example, yellow, orange, blue, green, pink, red and white.

In further accordance with this invention, a pneumatic rubber tire is provided having an integral innerliner of said butyl rubber composition in its cured state.

In practice, butyl rubber and halobutyl rubbers such as chlorobutyl rubber and bromobutyl rubber are well known to those having skill in such art for use in pneumatic tire innerliners for their air retention properties because of their relative air impermeability property. As hereinbefore discussed, corn cob granules can be included as a dispersion within the butyl rubber composition for a tire innerliner composition.

For the practice of this invention, the corncob granules are colored with a dye to contrast with the black colored butyl rubber matrix.

In practice, it is to be understood that the prescribed innerliner rubbers can be compounded with conventional rubber compounding ingredients comprised of, for example, carbon black, clay, talc, mica, silica, zinc oxide, stearic acid, rubber processing oil, sulfur, accelerator and antidegradant and then typically extruded and/or calendered to form the uncured gum strip. Such rubber compounding materials and methods are well known to those having skill in such art.

An important aspect of this invention is use of the dye colored organic corn cob granules which are sufficiently hard that they maintain their granular structure during high shear mixing of the black colored butyl rubber based rubber composition in which they are dispersed, typically at an elevated temperature and, further, which have sufficient porosity to suitably adsorb the colored dye (the non-black colored dye) onto and imbibe within the corn cob granules.

Therefore, it considered herein that such dyed corn cob granules are not a simple colored pigment but, instead, individual dye colored organic hard corn cob granules which have a degree of porosity sufficient to adsorb a colored dye and sufficiently hard to withstand high shear mixing of the black colored rubber matrix in which it is dispersed (the rubber matrix being black colored by the dispersion of rubber reinforcing carbon black in the rubber composition).

By this invention the dispersed dye colored corn cob granules are found to be significantly visible at the surface of the black rubber matrix.

Therefore, a significant aspect of the discovery of this invention is the intimate contact of the adsorbed and imbibed colored dye on the surface and within the corn cob granules together with the observed hardness of the organic corn cob granules to withstand the high shear processing (e.g. high shear mixing) of the black matrix rubber composition in which the dye colored corn cob granules are dispersed to maintain their granular configuration and to thereby provide an ability to visually observe the dyed corn cob granules against the background of the black rubber matrix, particularly after the high shear rubber mixing.

In practice, the uncured tire carcass rubber interface with which the innerliner is sulfur co-cured can be of various sulfur curable rubber blends such as, for example, cis 1,4-polybutadiene, cis 1,4-polyisoprene and styrene/butadiene copolymer rubbers which are exclusive of butyl rubber and halogenated butyl rubber.

Typically the innerliner has an uncured gum thickness in the range of about 0.03 to about 0.08 inch (0.08-0.2 cm), depending somewhat on the tire size, its intended use and degree of air retention desired. The term “gum” is intended to mean that the innerliner rubber is exclusive of fiber reinforcement.

The pneumatic tire with the integral innerliner composition may be constructed in the form of a passenger tire, truck tire, or other type of bias or radial pneumatic tire.

The following examples are presented to demonstrate the invention. The parts and percentages are by weight unless otherwise noted.

### EXAMPLE I

Samples of carbon black reinforced, black colored, bromobutyl rubber matrices are illustrated.

Rubber Control rubber Sample A does not contain a dispersion of corn cob granules.

Comparative rubber Samples B, C and D contain level of 2.5, 5 and 10 phr, respectively, of dispersions of corn cob granules.

Rubber Samples A through D are taken from and are therefore duplicative of rubber Samples 1, 2, 3 and 5 of Example I of U.S. Pat. No. 7,134,468.

Experimental rubber Sample E is prepared for this Example which contains a dispersion of colored corn cob granules, where said corn cob granules are colored with a dye adsorbed onto and imbibed within said corn cob granules.

The Samples were prepared by mixing the ingredients in an internal rubber mixer in a sequential series of non-productive (without sulfur and accelerators) mixing steps and followed by a final productive mixing step with sulfur and accelerator addition at a lower mix temperature. The rubber compositions were dumped from the rubber mixer after each mixing step, sheeted out from an open mill and allowed to cool to below 40° C. after each mixing step. The non-productive mixing steps were mixed for about 4 minutes to a temperature of about 150° C. The subsequent productive mixing step was conducted for about 2 minutes to a temperature of about 110° C.

Table 1 illustrates the ingredients used for preparing the rubber compositions of Control Sample A, Comparative rubber Samples B through D and Experimental rubber Sample E.

TABLE 1

| | Control | Comparative | | | Experimental |
|---|---|---|---|---|---|
| Rubber Samples | A | B | C | D | E |
| Non-Productive | | | | | |
| Mixing Step | | | | | |
| Bromobutyl rubber¹ | 100 | 100 | 100 | 100 | 100 |
| Carbon black² | 60 | 60 | 60 | 60 | 60 |
| Processing aids³ | 17.5 | 17.5 | 17.5 | 17.5 | 17.5 |
| Magnesium oxide | 0.15 | 0.15 | 0.15 | 0.15 | 0.15 |
| Corncob granules⁴ | 0 | 2.5 | 5.0 | 10 | 0 |
| Colored corncob | 0 | 0 | 0 | 0 | 5 |
| granules⁵ | | | | | |
| Productive | | | | | |
| Mixing Step | | | | | |
| Zinc oxide | 1 | 1 | 1 | 1 | 1 |
| Accelerators⁶ | 1.87 | 1.87 | 1.87 | 1.87 | 1.87 |

¹Bromobutyl rubber as Bromobutyl 2222 ™ from the ExxonMobil Company
²N660 rubber reinforcing carbon black, an ASTM designation
³Blend of Flexon 641 ™ from the ExxonMobil Company, Struktol 40MS ™ from the Struktol Company and fatty acids, including stearic acid
⁴Corn cob granules as 60 Grit-O′ cobs ® from The Andersons, Inc.
⁵Dye colored corn cob granules colored with a yellow colored dye to provide yellow colored corn cob granules to visibly contrast with the black rubber matrix
⁶Benzothiazyl disulfide and tetramethyl thiuram disulfide

The following Table 2 reports physical data for various physical properties of the Samples. For cured rubber samples, the respective samples were cured for about 23 minutes to a temperature of about 170° C.

TABLE 2

| | Control | Comparative | | | Experimental |
|---|---|---|---|---|---|
| Samples | A | B | C | D | E |
| Corn cob granules | 0 | 2.5 | 5 | 10 | 0 |
| Colored corn cob granules | 0 | 0 | 0 | 0 | 5 |
| Visual Observation of Corn cob Granule | N | N | N | N | Y |
| Dispersion in the Black Rubber Matrix | | | | | |
| (N = not easily visible and Y = easily visible | | | | | |
| Rheometer, 170° C. (MDR)¹ | | | | | |
| Maximum torque (dNm) | 3.9 | 4.2 | 4.1 | 4.4 | — |
| Minimum torque (dNm) | 1.5 | 1.5 | 1.5 | 1.6 | — |
| Delta torque (dNm) | 2.4 | 2.7 | 2.6 | 2.8 | — |
| T90, minutes | 9.4 | 8.8 | 8.8 | 7.9 | — |
| Stress-strain (ATS)² | | | | | |
| Tensile strength (MPa) | 6.9 | 6.6 | 5.9 | 5.4 | — |
| Elongation at break (%) | 804 | 720 | 701 | 655 | — |
| 300% modulus (MPa) | 2.5 | 2.7 | 2.6 | 2.7 | — |
| Rebound (%) | | | | | |
| 23° C. | 12 | 12 | 12 | 12 | — |
| 100° C. | 41 | 40 | 40 | 42 | — |
| Hardness (Shore A)³ | | | | | |
| 23° C. | 55 | 57 | 56 | 58 | — |
| 100° C. | 35 | 37 | 36 | 38 | — |
| Tear strength, 95° C. (N)4 | 84 | 91 | 77 | 70 | — |
| Pierced groove flex (mm @ 240 minutes)⁵ | 3 | 3.2 | 3.2 | 3.4 | — |
| Air permeability (cc/mil per 24 hours)⁶ | 44 | 40 | 36 | 36 | — |
| Brittle point, ° C.⁷ | −43 | −43 | −39 | −37 | — |
| RPA, 100° C., 1 Hz⁸ | | | | | |
| G′ at 10% strain (kPa) | 426 | 464 | 444 | 465 | — |
| Tan delta at 10% strain | 0.30 | 0.30 | 0.30 | 0.29 | — |

¹Data obtained according to Moving Die Rheometer instrument, model MDR-2000 by Alpha Technologies, used for determining cure characteristics of elastomeric materials, such as for example torque, T90 etc.
²Data obtained according to Automated Testing System instrument by the Instron Corporation which incorporates six tests in one system. Such instrument may determine ultimate tensile, ultimate elongation, modulii, etc. Data reported in the Table is generated by running the ring tensile test station which is an Instron 4201 load frame.
³Shore A hardness according to ASTM D-1415
⁴Data obtained according to a peel strength adhesion (tear strength) test to determine interfacial adhesion between two samples of a rubber composition. In particular, such interfacial adhesion is determined by pulling one rubber composition away from the other at a right angle to the untorn test specimen with the two ends of the rubber compositions being pulled apart at a 180° angle to each other using an Instron instrument.
⁵Pierced groove flex values were determined by continuous dynamic flexing and measuring the extent of crack growth and expressed in terms of millimeters (mm) at 240 minutes of flexing at 23° C.
⁶Air permeability was determined by ASTM D-143
⁷Brittle Point value according to ASTM D-746
⁸Data obtained according to Rubber Process Analyzer as RPA 2000 ™ instrument by Alpha Technologies, formerly the Flexsys Company and formerly the Monsanto Company. References to an RPA-2000 instrument may be found in the following publications: H. A. Palowski, et al, Rubber World, June 1992 and January 1997, as well as Rubber & Plastics News, April 26, and May 10, 1993.

From Table 2 it is observed that up to 10 phr of the corncob granules can be added to a 100 phr bromobutyl rubber innerliner composition without significant loss of the indicated innerliner rubber physical properties as previously demonstrated in Example I of U.S. Pat. No. 7,134,468 from which the data for rubber Samples A through D herein was taken.

From Table 2 it is further observed that the corn cob granules in rubber Samples B through D were not easily visually observable whereas the visibly yellow dye colored hard organic corn cob granules in rubber Sample E maintained their granular structure after their high shear mixing in the black colored (black colored via the inclusion of the rubber reinforcing carbon black) butyl rubber based rubber composition were easily observable which demonstrated that the dispersion of the yellow dye colored hard organic corn cob granules in the black colored butyl rubber matrix can be used to achieve and enable a desired visual observation of the black colored rubber sample. The visual presence of the yellow dye colored uncured and cured black rubber composition matrix was evident as indicated in Table 2. Such visual presence of the color dyed corn cob granules against black rubber composition matrix enables segregation of the black colored uncured butyl rubber composition from other black matrix rubber compositions which do not contain the color dyed corn cob granules in the black rubber matrix which can beneficially aid in preventing cross-contamination of the rubber compositions in the work place, where both types of black colored rubber compositions are present, prior to building and curing the rubber article, such as an assembly of rubber components for a tire assembly. The cured physical properties for the yellow dye colored corn cob granules of rubber Sample E are not shown since they are expected to be the same or similar to the cured physical properties of rubber Sample C which contained 5 parts of the corn cob granules which had not been dyed.

Such use of the dispersion of yellow dye colored corn cob granules in the black colored butyl rubber composition is also considered herein to be significant because it allows for a significant reduction of cost of innerliner rubber composition (resulting from the significantly low cost of the corncob granules as compared to the cost of the butyl type rubber) without significant loss of innerliner physical properties and some improvement in air permeability resistance and lower brittle point for improved low temperature performance.

While certain representative embodiments and details have been shown for the purpose of illustrating the invention, it will be apparent to those skilled in this art that various changes and modifications may be made therein without departing from the spirit or scope of the invention.

What is claimed is:

1. An uncured black colored butyl rubber based rubber composition containing a dispersion of visually identifiable dye colored corn cob granules comprised of:
(A) an uncured black colored butyl rubber composition containing reinforcing carbon black wherein said butyl rubber is comprised of at least one of butyl rubber and halogenated butyl rubber, wherein said halogenated butyl rubber is selected from chlorobutyl rubber and bromobutyl rubber, and
(B) a dispersion within said black colored butyl rubber composition of dye colored corn cob granules, wherein said corn cob granules are colored with a dye adsorbed onto and imbibed within said corn cob granules which imparts color to said corn cob granules, wherein the dyed color of said colored corn cob granules contrasts with the black color of said black colored butyl rubber composition and are visible on the surface of said black colored butyl rubber composition.

2. The uncured black colored butyl rubber composition of claim 1 wherein said dye colored corn cob granules are dye colored with a color comprised of yellow, orange, blue, green, pink, red or white.

3. A method of visually segregating uncured black colored butyl rubber composition from black colored uncured conjugated diene elastomer based rubber composition which comprises providing said butyl rubber composition with a dispersion of dye colored corn cob granules, wherein said corn cob granules are colored with a dye adsorbed onto and imbibed within said corn cob granules which imparts color to said corn cob granules, wherein the dyed color of said colored corn cob granules contrasts with the black color of said black colored butyl rubber composition and are visible on the surface of said black colored butyl rubber composition,
wherein said uncured butyl rubber composition contains rubber reinforcing carbon black and butyl rubber comprised of at least one of butyl rubber and halogenated butyl rubber wherein said halogenated butyl rubber is comprised of at least one of chlorobutyl and bromobutyl rubber, and
wherein said uncured conjugated diene elastomer based rubber composition is exclusive of said butyl rubber.

4. The method of claim 3 wherein said dye colored corn cob granules are dye colored with a color comprised of yellow, orange, blue, green, pink, red or white.

5. A pneumatic rubber tire having a sulfur cured integral innerliner of said butyl rubber composition of claim 1.

6. A pneumatic rubber tire having a sulfur cured integral innerliner of said butyl rubber composition of claim 2.

7. In a combination of rubber compositions comprised individually and separately:
(A) at least one black colored uncured butyl rubber composition which contains rubber reinforcing carbon black and butyl rubber comprised of at least one of butyl rubber and halogenated butyl rubber, and
(B) at least one black colored uncured conjugated diene-based elastomer containing rubber composition which contains rubber reinforcing carbon black and is exclusive of butyl rubber and halogenated butyl rubber;
an identifying means for said black colored uncured butyl rubber composition which comprises:
providing said black colored uncured butyl rubber composition with a dispersion of dye colored corn cob granules dispersion of dye colored corn cob granules, wherein said corn cob granules are colored with a dye adsorbed onto and imbibed within said corn cob granules which imparts color to said corn cob granules, wherein the dyed color of said colored corn cob granules contrasts with the black color of said black colored butyl rubber composition and are visible on the surface of said black colored butyl rubber composition,
wherein said black colored uncured conjugated diene-based elastomer containing rubber composition is exclusive of said dye colored corn cob granules.

8. The combination of rubber compositions of claim 7 wherein said dye colored corn cob granules are dye colored with a color comprised of yellow, orange, blue, green, pink, red or white.

9. The black colored butyl rubber based rubber composition of claim 1 wherein said dye colored organic corn cob granules are sufficiently hard that they maintain their granular structure during high shear mixing of said uncured black colored butyl rubber based rubber composition in which they are dispersed and have sufficient porosity to adsorb and imbibe said colored dye.

10. The method of claim 3 wherein said dye colored organic corn cob granules are sufficiently hard that they maintain their granular structure during high shear mixing of said uncured black colored butyl rubber based rubber composition in which they are dispersed and have sufficient porosity to adsorb and imbibe said colored dye.

11. The combination of rubber compositions of claim 7 wherein said dye colored organic corn cob granules are sufficiently hard that they maintain their granular structure during high shear mixing of said uncured black colored butyl rubber based rubber composition in which they are dispersed and have sufficient porosity to adsorb and imbibe said colored dye.
